(19) United States
(12) Patent Application Publication
(10) Pub. No.: US 2013/0083948 A1
(43) Pub. Date: Apr. 4, 2013

(54) AUTOMATIC AUDIO SWEET SPOT CONTROL

(71) Applicant: Brian Lloyd Schmidt, Bellevue, WA (US)

(72) Inventor: Brian Lloyd Schmidt, Bellevue, WA (US)

(73) Assignee: QSound Labs, Inc.

(21) Appl. No.: 13/253,062

(22) Filed: Oct. 4, 2011

(51) Int. Cl. H04R 5/02

(52) U.S. Cl. 381/303

(57) ABSTRACT

A handheld device includes: an orientation sensor; an audio processor connected to the orientation sensor and adapted to receive orientation information from the orientation sensor; and a plurality of speakers through which audio content is provided, wherein the audio processor modifies the audio signal provided to the speakers based, at least in part, on the orientation information. A method of controlling audio content provided through a plurality of speakers in the device includes the steps of: determining a neutral orientation of the sweet spot; using information from the orientation sensor to measure the relative orientation of the device; and determining whether the relative orientation of the device has changed. If the relative orientation of the device has changed, modifying the audio content provided through the speakers.

### BACKGROUND OF THE INVENTION

The present subject matter provides a mobile and/or handheld audio system including two or more speakers and an orientation sensor, the output of which is used to control the location of the audio sweet spot. In some examples of the systems and methods provided herein, facial recognition systems and methods are used to further orient and adapt the location of the audio sweet spot.

While listening to audio, the quality of the sound localization and imaging depends on the relative position of the listener and the speakers. In a two-speaker system, the ideal position for the listener, known as the “sweet spot,” is generally any position approximately equidistant from the two speakers. In two-speaker audio systems, the “sweet spot” is actually a region (a number of spots) generally located along a plane that is perpendicular to and bisects a line drawn between the two speakers.

The sweet spot concept also applies to methods of delivering stereo content using more than two speakers, for example when speaker arrays are used in two-channel audio. Further, the sweet spot concept applies with multichannel audio content with greater than two channels as well (e.g., various surround sound systems). In addition to these multichannel audio systems, the sweet spot is also important in “virtualized audio,” wherein various audio processing algorithms are used to create an illusion of three-dimensional audio from two or more speakers. An example of such audio processing algorithms is head-related transfer function processing.

Sweet spot location is particularly troublesome when dealing with audio systems incorporated into handheld devices, especially when the audio content is related to user interaction. For example, when playing a video game on a handheld device (i.e., dedicated game system, smartphone, etc.), the user's body and hand movements can change the relative position and angle between the speakers and the user. Such movements may occur as the player tries to add “english” to their game play; for example, leaning to one side or other as they steer in a driving game, or tilting the handheld device to perform game actions.

FIG. 1 illustrates an example of a two-speaker audio system in which a listener is located at the sweet spot. FIG. 2 shows an example in which the listener leaves the sweet spot, due to the rotation of the handheld device. FIG. 3 shows an example in which the user leaves the sweet spot, due to the translation of the handheld device. In the relative orientations shown in FIGS. 2 and 3, the audio quality suffers, particularly due to poor sound localization and imaging.

It is possible to compensate for the imperfect relative orientation between the user and the audio system. Such methods for “steering the sweet spot” by adjusting the audio output signals from the speakers are known in the audio field. For example, methods of adapting the sweet spot to match a user's position using facial recognition technology to track the listener's position are described in papers by Sebastian Merchal and Stephan Groth, including: (1) Analysis and Implementation of a Stereophonic Play Back System for Adjusting the “Sweet Spot” to the Listener's Position, Proceedings of 126^{th} AES Convention, Munich, Germany, 2009; (2) Analysis and Implementation of a Stereophonic Play Back System for Adjusting the “Sweet Spot” to the Listener's Position, Journal of the Audio Engineering Society, 58(10) 2010, 809-817; and (3) Evaluation of a New Stereophonic Reproduction Method with Moving “Sweet Spot” Using a Binaural Localization Model, Proceedings of ISAAR Symposium, Helsingor, Denmark, 2009; the entirety of which are incorporated by reference herein.

FIG. 4 illustrates the effects of steering the audio sweet spot. As shown, the original location of the sweet spot is misaligned with respect to the listener, but the steered sweet spot is perfectly aligned.

While an improvement over previous technology, such known methods rely on facial recognition equipment and software, which may not be the ideal solution in all situations and with all types of devices. For example, some handheld devices in which sweet spot control may be beneficial may lack the appropriate hardware required for facial recognition. Further, the hardware and software required to implement facial recognition may be too costly or resource intensive in certain implementations. Moreover, the effectiveness of solutions based on facial recognition technology is severely limited when the user is out of the field of view of the facial recognition hardware.

Accordingly, there is a need for a system and method for controlling the orientation of the sweet spot in a multichannel audio system, as described and claimed herein.

### SUMMARY OF THE INVENTION

In order to meet these needs and others, the present invention provides a system and method in which an orientation sensor is used to control the sweet spot in a mobile and/or handheld audio system.

In one example, a mobile handheld audio system includes two or more speakers and an orientation sensor, the output of which is used to control the location of the audio sweet spot. In an additional example, facial recognition systems and methods are used to further orient and adapt the location of the audio sweet spot.

In a primary example, the mobile handheld audio system includes a pair of speakers used to output stereo audio content. An audio processor controls the output of the speakers. An orientation sensor provides an orientation signal to the audio processor, which uses the orientation signal to manipulate the position of the sweet spot of the audio content output by the speakers. Accordingly, as the handheld device changes orientation, the relative position of the sweet spot is adapted to provide improved audio to the user. In alternate examples, facial recognition hardware and software may be utilized to determine the proper orientation of the sweet spot with respect to the device.

In use, the audio system may start with the sweet spot in a neutral initial orientation. In systems incorporating facial recognition technology, the initial orientation of the sweet spot may be adapted to match the relative location of the user. As audio is played through the speakers, the orientation sensor provides orientation information to the audio processor, which in turn uses the orientation data to steer the sweet spot to correspond to the position of the user. The sweet spot orientation may be controlled in real-time.

In embodiments in which a combination of information from the orientation sensor and the facial recognition hardware are used to steer the sweet spot, it is understood that the orientation sensor may provide information used to steer the sweet spot, even then the user is out of range of the facial recognition hardware. For example, facial recognition may be primarily used to track a listener's head. Then, in the event the listener's face goes out of the field of view of the camera, the orientation sensor can continue to track the listener's presumed position and adjust the sweet spot accordingly. When the face comes back into the field of view, the orientation sensor can then be re-calibrated through facial recognition.

The control and adaption of the sweet spot by the audio processor may be subject to one or more stabilization algorithms that prevent overcorrection of the sweet spot. For example, the audio processor may require a minimum change in orientation angle or may require a minimum duration of orientation shift before the audio signal is modified to control the sweet spot location. Further, the audio processor may use a running average of the last N positions as a basis for position information or utilize other known data smoothing techniques.

There are numerous elements that may function as an orientation sensor. Illustrative examples include: GPS receivers, compasses, accelerometers, position sensors, inertial sensor, etc. While not commonly incorporated into current handheld devices, it is understood that sensors based on radar, sonar or the like may be used to acquire further orientation and/or location information that may be used to steer or orient the sweet spot.

Further, it is understood that in multichannel audio systems in which more than two speakers are used, the sweet spot may be steered closer to or further from the device based on input from either the orientation sensor and/or facial recognition.

In addition, in multichannel audio systems, particularly those with more than two speakers, the process of steering the sweet spot may include increasing or decreasing the number of speakers used to produce the audio content. For example, in a four speaker system in which a generally square device includes a speaker at approximately each of the four corners, a selected pair of speakers may be used to provide the audio content in each orientation. The speakers selected for the playback may be adjacent speakers in some orientations (when the device is oriented square to the user) and may be opposing speakers in other orientations (when the device is oriented diagonally to the user).

In one example of a system embodying the solutions provided herein, a handheld device includes: an orientation sensor; an audio processor connected to the orientation sensor and adapted to receive orientation information from the orientation sensor; and a plurality of speakers through which audio content is provided, wherein the operation of the speakers is controlled by the audio processor, wherein the audio processor modifies the audio signal provided to the speakers based, at least in part, on the orientation information. In some embodiments, the audio processor uses the orientation information to steer the sweet spot of the audio content.

The handheld device may further include a camera connected to the audio processor, wherein the camera provides visual information to the audio processor, further wherein the audio processor also uses the visual information to steer the sweet spot of the audio content. In this example, the orientation sensor may be an accelerometer and there may be two speakers. Of course in other embodiments, the orientation sensor may be another type of sensor and further the speakers may be a speaker array.

In one embodiment of a method for realizing the solutions provided herein, audio content is provided through a plurality of speakers in a device including an orientation sensor and audio processor, the method includes the steps of: determining a neutral orientation of the sweet spot of the audio content to be provided through the speakers; periodically, during the operation of the device, using information from the orientation sensor to measure the relative orientation of the device; comparing the present relative orientation of the device to the previous relative orientation of the device; and determining whether the relative orientation of the device has changed, wherein, if the relative orientation of the device has not changed, not modifying the audio content provided through the speakers and, if the relative orientation of the device has changed, modifying the audio content provided through the speakers. In certain embodiments, the step of modifying the audio content includes steering the sweet spot of the audio provided through the speakers. In some embodiments, the step of determining a neutral orientation of the sweet spot includes using information from the orientation sensor to determine a neutral orientation. Further, in alternate embodiments, the neutral orientation of the sweet spot may be determined using a predetermined orientation. The step of determining the relative orientation of the device may include using a data smoothing technique, for example, by using a running average for the relative orientation of the device.

The device used in the method may further include a camera and the method may further including the step of determining whether a user's face is visible using visual information from the camera. The visual information may be used in the step of determining a neutral orientation of the sweet spot of the audio content to be provided through the speakers. Additionally or alternatively, the visual information is used in the step of determining whether the relative orientation of the device has changed. In some examples, the visual information may be collected at a lower frequency than the collection of the orientation information, for example, to improve battery life and conserve processing resources.

In another example of the solutions provided herein, computer readable media including computer-executable instructions for controlling audio content provided through a plurality of speakers in a device including an orientation sensor and audio processor, the computer-executable instructions causing a system to perform the steps of: determining a neutral orientation of the sweet spot of the audio content to be provided through the speakers; periodically, during the operation of the device, using information from the orientation sensor to measure the relative orientation of the device; comparing the present relative orientation of the device to the previous relative orientation of the device; and determining whether the relative orientation of the device has changed, wherein, if the relative orientation of the device has not changed, not modifying the audio content provided through the speakers and, if the relative orientation of the device has changed, modifying the audio content provided through the speakers.

The device may further include a camera and the computer-executable instructions may further cause the device to perform the step of determining whether a user's face is visible using visual information from the camera. The visual information may also be used in the step of determining a neutral orientation of the sweet spot of the audio content to be provided through the speakers and/or the visual information may be used in the step of determining whether the relative orientation of the device has changed.

An advantage of the systems and methods provided herein is that the sweet spot orientation of a mobile and/or handheld audio source may controlled based on the information received from an orientation sensor.

Another advantage of the systems and methods provided herein is that the control of the sweet spot may be implemented without requiring facial recognition systems.

Additional objects, advantages and novel features of the present subject matter will be set forth in the following description and will be apparent to those having ordinary skill in the art in light of the disclosure provided herein. The objects and advantages of the invention may be realized through the disclosed embodiments, including those particularly identified in the appended claims.

### BRIEF DESCRIPTION OF THE DRAWINGS

The drawings depict one or more implementations of the present subject matter by way of example, not by way of limitation. In the figures, the reference numbers refer to the same or similar elements across the various drawings.

FIG. 1 is a top view of a two channel audio system, a listener and the sweet spot, in which the listener is shown positioned along the sweet spot.

FIG. 2 is top view of a two channel audio system, a listener and the sweet spot, in which the sweet spot is shown transversely misaligned with respect to the listener's position.

FIG. 3 is top view of a two channel audio system, a listener and the sweet spot, in which the sweet spot is shown at a skewed angle with respect to the listener's position.

FIG. 4 is a top view of a two channel audio system, a listener, the location of the original and the steered sweet spots.

FIG. 5 is a schematic representation of a handheld device that uses an orientation sensor to control the sweet spot of audio content from a pair of speakers.

FIG. 6 is a flow chart illustrating a method of automatically relocating the sweet spot of audio output from a handheld device based on the output of an orientation sensor.

FIG. 7 is a flow chart illustrating a method of calibrating orientation of a sweet spot based on facial recognition and then automatically relocating the sweet spot of audio output from a handheld device based on the output of an orientation sensor.

### DETAILED DESCRIPTION OF THE INVENTION

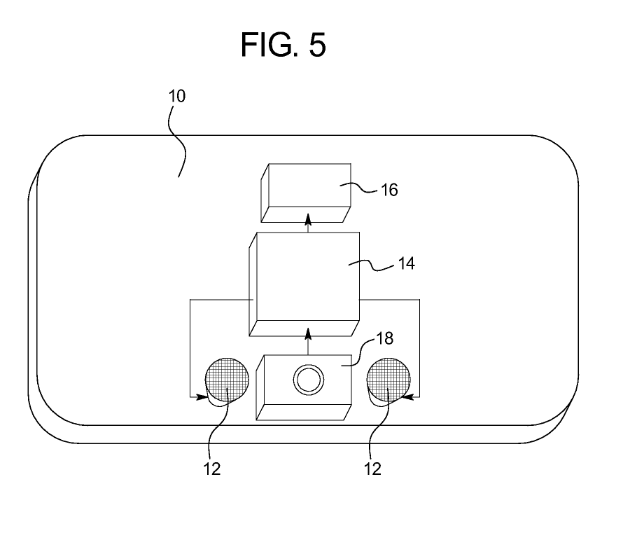

FIG. 5 illustrates a preferred embodiment of a handheld device 10 according to the present invention. As shown in FIG. 5, the device 10 includes two speakers 12, an audio processor 14, an orientation sensor 16 and a camera 18. In the example shown in FIG. 5, the device 10 is a handheld game console. However, it is understood that the present invention is applicable to numerous types of devices 10, including smartphones, handheld computers, etc. It is further contemplated that various embodiments of the device 10 may incorporate a greater number of speakers 12, various types and numbers of orientation sensors 16, and may or may not include the camera 18 or other types of location sensing elements.

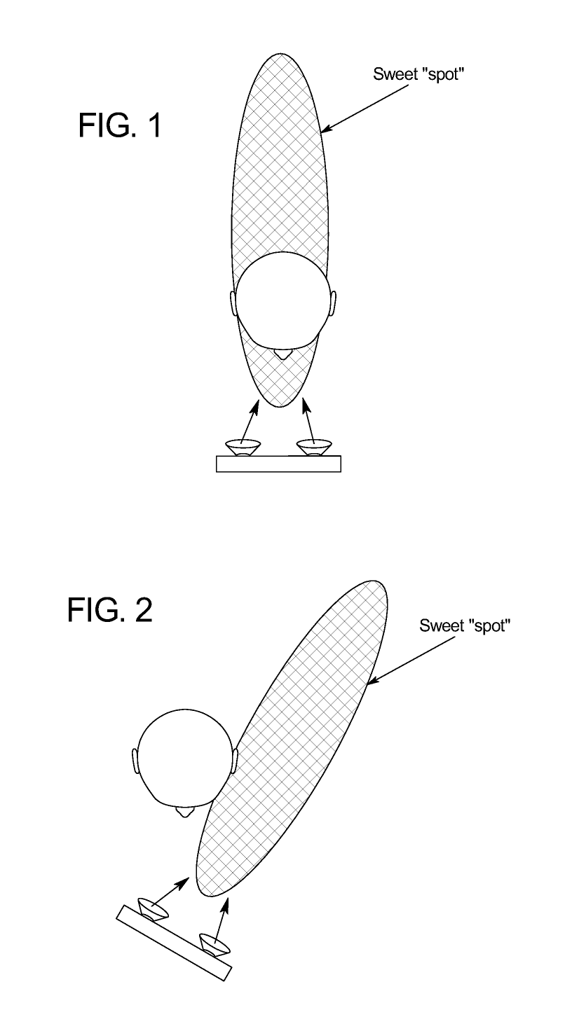

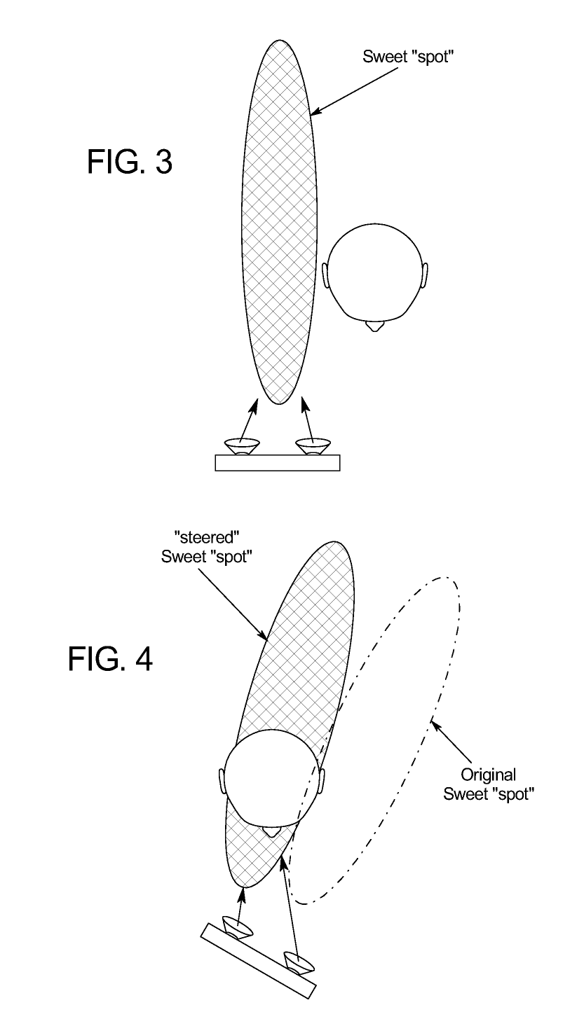

The speakers 12 shown in FIG. 1 are a pair of speakers 12 for playback of stereo audio content. Special speakers 12 are not required; the teachings of the present subject matter are applicable to devices 10 incorporating any type of speakers 12.

While described generally herein with respect to stereo audio content provided through a pair of speakers 12, the present subject matter may be applied to devices that incorporate a greater number of speaker 12 and/or a greater number of audio channels. For example, an array of speakers 12 may be used to provide stereo audio content. Alternatively, three or more speakers 12 may be used to provide three or more separate audio channels. Further, while shown oriented along a common face of the device 10, it is understood that the speakers 12 may be oriented along multiple faces or in multiple directions.

The audio content is provided to the speakers 12 through an audio processor 14. The audio processor 14 receives data inputs from the orientation sensor 16 and the camera 18 and processes the audio content to steer the sweet spot, as described further herein. The audio processor 14 may be any type of audio processor, including the sound card and/or audio processing units in typical handheld devices 10. An example of an appropriate audio processor 14 is a general purpose CPU such as those typically found in handheld devices, smartphones, etc. Alternatively, the audio processor 14 may be a dedicated audio processing device.

The orientation sensor 16 in the example shown in FIG. 5 is an accelerometer. However, as noted above, there are numerous types of orientation sensors 16 that may be used in the device 10. Further, the output of multiple types of orientation sensors may be used in combination as input to the audio processor 14. For example, the combination of an accelerometer and a position sensor may be used to supply the audio processor 14 with various forms of orientation data.

The camera 18 shown in FIG. 5 is a standard camera 18, the type of which is typically included in handheld devices 10. However, it is understood that various types of cameras 18 may be used to implement the solutions provided herein, including cameras operating in various spectrums (e.g., infrared, ultraviolet, etc.), range cameras, ultrasonic cameras.

The camera 18 shown in FIG. 5 is located on the same face of the device 10 as the speakers 12 to most closely monitor the natural sweet spot location of the speakers 12. Though, the camera 18 may be located anywhere on the device 10 that enables the camera 18 to monitor the field of view in which the sweet spot is most likely to be desired. Further, it is contemplated that a plurality of cameras 18 may be used along one or multiple faces of the device 10 to increase the field of view of the camera 18 data or to provide a greater amount of detailed data within a given field of view. For example, a pair of cameras 18 may be provided to enable stereoscopic data to be collected to determine the distance of a user from the device 10.

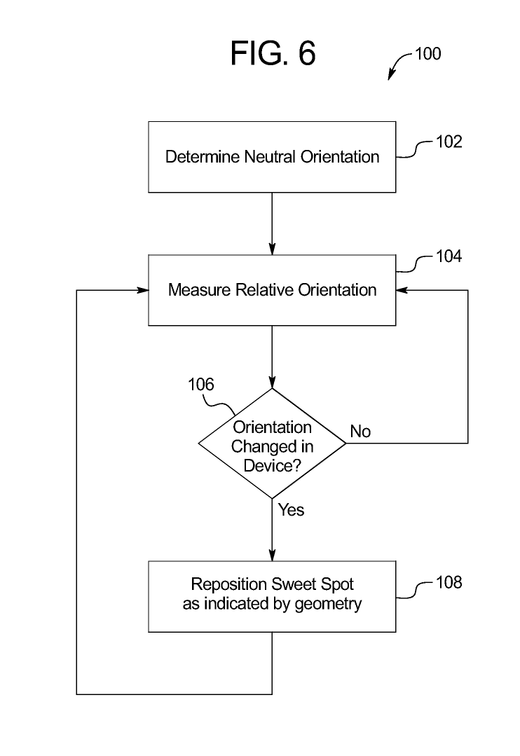

Turning now to FIG. 6, a process flow for automatic sweet spot adaptation 100 is provided (referred to herein as process 100). As shown in FIG. 6, the process 100 includes a first step 102 of determining a neutral orientation of the sweet spot. For example, the audio processor 14 may use the data collected from orientation sensor 16 to determine the initial orientation of the device 10 and the neutral orientation of the sweet spot. In examples in which a camera 18 is incorporated into the device 10, data collected from the camera 18 may further be used to determine the initial orientation of the device 10 and the neutral orientation of the sweet spot.

After determining the neutral orientation of the sweet spot in the first step 102, the orientation data received from the orientation sensor 16 (and/or camera 18) is used to measure the relative orientation of the device 10 in a second step 104.

As shown in the third step 106, if the orientation of the device 10 has not changed, the process 100 cycles back to the second step 104 to measure the relative orientation of the device 10.

If the orientation of the device has changed, the process 100 moves to a fourth step 108, in which the audio processor 14 repositions the sweet spot as determined based on the orientation data. For example, if the orientation sensor 16 informs the audio processor 14 that the relative angle of the device 10 has shifted ten degrees off-axis, the audio processor 14 may adjust the sweet spot to match the relative angle shift. Similarly, if the orientation sensor 16 informs the audio processor 14 that the device 10 has shifted eight inches to the left, the audio processor 14 may adjust the sweet spot to match the shift of the device 10.

The process 100 then cycles back to the second step 104, in which the device 10 measures its relative orientation, as shown in FIG. 6.

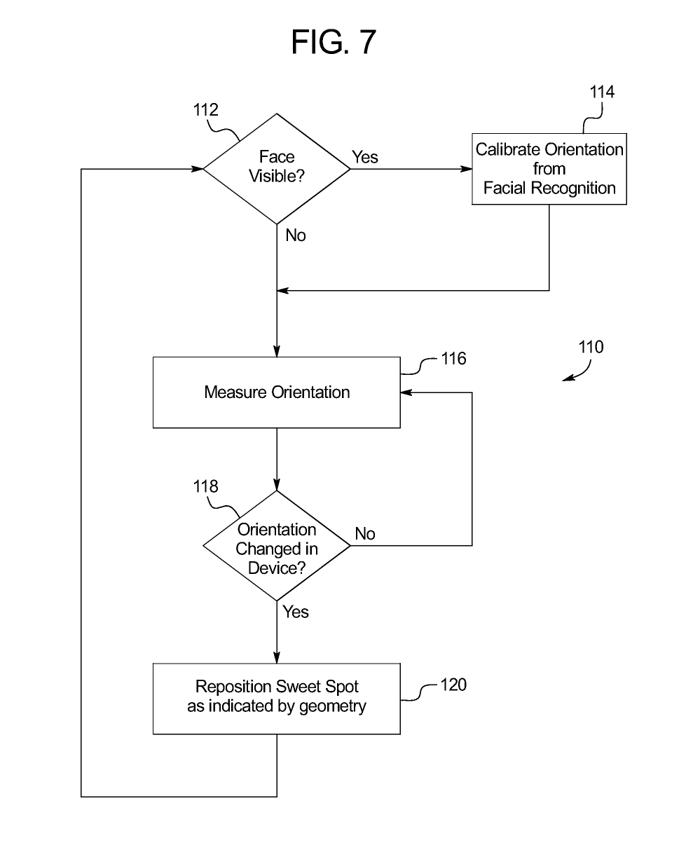

FIG. 7 illustrates another process flow for automatic sweet spot adaptation 110 (referred to herein as process 110). In this example, facial recognition is used to assist in the calibration and orientation of the sweet spot. As shown in FIG. 7, the process 110 includes a first step 112 of determining whether the user's face is visible. If the user's face is visible, the audio processor 14 calibrates the orientation of the sweet spot based on the facial recognition data collected from the camera 18 in a second step 114. The location of the user's face is used to set the reference point and the readings from any orientation sensors 16 are referenced as neutral relative orientation, even if the orientation data indicates a non-neutral absolute orientation.

The first step 112 may be optional and/or may be implemented once every given number of cycles (or period of time). Implementing the first step 112 less than once per process 110 cycle may be a good way to reduce the power consumption of the process 112.

If the user's face is not visible, the orientation data from the orientation sensor 16 may be used to set the neutral reference point.

Once the neutral orientation is established, the data received from the orientation sensor 16 and camera 18 is used to measure the relative orientation of the device 10 in a third step 116.

As shown in the fourth step 118, if the orientation of the device 10 has not changed, the process 100 cycles back to the third step 116 to measure the relative orientation of the device 10.

If the orientation of the device has changed, the process 100 moves to a fifth step 120, in which the audio processor 14 repositions the sweet spot as determined based on the orientation data.

The process 110 then cycles back to the first step 112, in which the device 10 determines whether the user's face is visible, as shown in FIG. 7.

Accordingly, in embodiments in which a combination of information from the orientation sensor 16 and the camera 18 are used to steer the sweet spot, it is understood that the orientation sensor 16 may provide information used to steer the sweet spot, even then the user is out of range of the camera 18. For example, facial recognition may be primarily used to track a listener's head. Then, in the event the listener's face goes out of the field of view of the camera 18, the orientation sensor 16 can continue to track the user's presumed position and adjust the sweet spot accordingly. When the face comes back into the field of view, the orientation sensor 16 can then be re-calibrated through facial recognition.

Of course, the processes 100 and 110 shown in FIGS. 6 and 7 are merely representative examples of processes that may be used to implement the solutions provided by the present subject matter. Any number of alternative processes may be implemented through which the data from the orientation sensor 16 and/or the camera 18 are used by the audio processor 14 to control the audio content output through the speakers 12 to steer the sweet spot to compensate for the change in relative orientation of the device.

The control and adaption of the sweet spot by the audio processor 14 may be subject to one or more stabilization algorithms that prevent overcorrection of the sweet spot. For example, the audio processor 14 may require a minimum change in orientation angle or may require a minimum duration of orientation shift before the audio signal is modified to control the sweet spot location.

While described primarily herein with respect to stereo audio signals output through two speakers 12, the teachings of the present subject matter are applicable to audio systems with a greater number of speakers 12, whether in speaker arrays, multichannel systems or in devices 10 with speakers 12 facing various directions to accommodate multiple orientations of the device 10. In addition to the steering of the sweet spot, the audio processor 14 may select a specific subset of the speakers 12 to output the audio program to assist in the steering of the sweet spot during playback.

It should be noted that various changes and modifications to the presently preferred embodiments described herein will be apparent to those skilled in the art. Such changes and modification may be made without departing from the spirit and scope of the present invention and without diminishing its advantages.

I claim:

1. A handheld device comprising:
an orientation sensor;
an audio processor connected to the orientation sensor and adapted to receive orientation information from the orientation sensor; and
a plurality of speakers through which audio content is provided, wherein the audio processor modifies the audio signal provided to the speakers based, at least in part, on the orientation information.

2. The handheld device of claim 1 wherein the audio processor uses the orientation information to modify the audio signal to steer the sweet spot of the audio content.

3. The handheld device of claim 2 wherein the audio processor modifies the audio signal using digital signal processing.

4. The handheld device of claim 2 further including a camera connected to the audio processor, wherein the camera provides visual information to the audio processor, further wherein the audio processor also uses the visual information to steer the sweet spot of the audio content.

5. The handheld device of claim 1 wherein the plurality of speakers is two speakers.

6. The handheld device of claim 1 wherein the plurality of speakers is a speaker array.

7. A method of modifying audio content provided through a plurality of speakers in a device including an orientation sensor and audio processor, the method comprising the steps of:
determining a neutral orientation of the sweet spot of the audio content to be provided through the speakers;
periodically, during the operation of the device, using information from the orientation sensor to measure the relative orientation of the device;
comparing the present relative orientation of the device to the previous relative orientation of the device; and
determining whether the relative orientation of the device has changed, wherein, if the relative orientation of the device has not changed, not modifying the audio content provided through the speakers and, if the relative orientation of the device has changed, modifying the audio content provided through the speakers.

8. The method of claim 7 wherein the step of modifying the audio content includes steering the sweet spot of the audio provided through the speakers using digital signal processing.

9. The method of claim 7 wherein the step of determining a neutral orientation of the sweet spot includes using information from the orientation sensor to determine a neutral orientation.

10. The method of claim 7 wherein the neutral orientation of the sweet spot is determined using a predetermined orientation.

11. The method of claim 7 wherein the step of determining the relative orientation of the device includes a data smoothing technique.

12. The method of claim 11 wherein the data smoothing technique includes using a running average for the relative orientation of the device.

13. The method of claim 7 wherein the device further includes a camera and further including the step of determining whether a user's face is visible using visual information from the camera.

14. The method of claim 13 wherein the visual information is used in the step of determining a neutral orientation of the sweet spot of the audio content to be provided through the speakers.

15. The method of claim 13 wherein the visual information is used in the step of determining whether the relative orientation of the device has changed.

16. The method of claim 13 wherein the visual information is collected at a lower frequency than the collection of the orientation information.

17. Computer readable media including computer-executable instructions for modifying audio content provided through a plurality of speakers in a device including an orientation sensor and audio processor, the computer-executable instructions causing a system to perform the steps of:
determining a neutral orientation of the sweet spot of the audio content to be provided through the speakers;
periodically, during the operation of the device, using information from the orientation sensor to measure the relative orientation of the device;
comparing the present relative orientation of the device to the previous relative orientation of the device; and
determining whether the relative orientation of the device has changed, wherein, if the relative orientation of the device has not changed, not modifying the audio content provided through the speakers and, if the relative orientation of the device has changed, modifying the audio content provided through the speakers.

18. The computer readable media of claim 17 wherein the device further includes a camera and the computer-executable instructions cause the device to perform the step of determining whether a user's face is visible using visual information from the camera.

19. The computer readable media of claim 18 wherein the visual information is used in the step of determining a neutral orientation of the sweet spot of the audio content to be provided through the speakers.

20. The computer readable media of claim 18 wherein the visual information is used in the step of determining whether the relative orientation of the device has changed.
